(19) United States
(12) Patent Application Publication
(10) Pub. No.: US 2010/0174615 A1
(43) Pub. Date: Jul. 8, 2010

(54) System and Method for Processing Orders for the Procurement of Reprints

(76) Inventor: Richard Haralson Weaver, Easton, CT (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/348,833

(22) Filed: Jan. 5, 2009

(51) Int. Cl. G06Q 30/00; G06Q 10/00; G06Q 50/00

(52) U.S. Cl. 705/26; 705/400

(57) ABSTRACT

The present invention relates to a system and method for aggregating orders for a requested reprint to allow an organization to effectively capture bulk discounts afforded by reprint providers. The system and method generates a quote related to the acquisition of the requested reprint. The generated quotes can be updated in real time based on an alteration to the aggregate quantity of requested reprints. The system and method publishes the quote to allow interested users to become aware of available content and the reprint cost for ordering the requested reprint.

### FIELD OF THE INVENTION

The present invention relates to a system and method for aggregating content procurement requests in order to maximize savings by leveraging bulk order discounting.

### BACKGROUND OF THE INVENTION

A document or reprint provider customarily provides ‘bulk’ discounts to a customer based on the quantity of reprints ordered. Typically, as the number of ordered reprints increases, the price per reprint or unit cost decreases. The terms and conditions relating to the bulk discount offered by a reprint provider is generally governed by a contractual agreement between the publisher and a given company or organization. Unfortunately, it is difficult for many organizations to capture the benefits of bulk pricing because the organization is often unaware of the real-time purchasing activities of their employees. In this regard, multiple employees often place separate orders for the same reprint, without any centralized tracking of the orders. As a result, the individual orders are not aggregated, and the organization fails to capture the entire bulk discount available to them pursuant to their contractual agreement with the publisher.

For example, in conventional arrangements, two employees may each place individual orders for 10 copies of a particular reprint. Without aggregation, each order receives a unit cost per reprint based on a total of 10 reprints. As such, the fully leveraged bulk discount based on an aggregated quantity of 20 reprints is not achieved by the organization. This approach results in a failure to optimize potential savings that the company is otherwise entitled to pursuant to their agreement with the publisher.

A primary reason for this inefficiency is the lack of real-time information sharing among employees regarding reprint ordering activity, particularly at large, geographically-dispersed companies. Moreover, large companies lack a formal mechanism to track their employees' reprint ordering activity in a meaningful way.

Some conventional order procurement systems provide for rudimentary order aggregation. However, these conventional order procurement systems do not update order related information upon the receipt of each order. Instead, conventional systems pool orders in an ad hoc and arbitrary fashion, and may only update order related information after the passage of a certain amount of time or after the receipt of a certain number of orders.

Therefore, there is a need in the art for a system and method for the centralized aggregation of reprint orders and the ability to distribute information concerning reprint ordering activity to other employees of the company, to maximize and focus reprint purchasing activities and fully leverage the company's realization of bulk discounts offered by the reprint publishers. In addition, there is a need in the art for a system and method that provides order aggregation wherein order related information is updated in response to the receipt of each additional order.

### SUMMARY OF THE INVENTION

Embodiments of the present invention satisfy these needs and others by providing a system and method for aggregating reprint procurement requests or orders received from a plurality of users associated with an organization (e.g., a company). In addition, the system and related methods of the present invention (herein referred to as the ‘order fulfillment system’) provide notification to a plurality of users of the reprint purchasing activities of other users at the company. As a result, by utilizing the order fulfillment system, the organization is able to maximize bulk discounts offered by the reprint publishers.

Through the management, tracking, control and aggregation of reprint orders placed by a large number of employees, an organization may more effectively capture bulk discounts. Instead of placing individual orders for each employee's reprint request according to the conventional ad hoc approach to order management, the system and method of the present invention allows for the centralized and automated aggregation of individual orders into a single robust order.

According to an embodiment of the present invention, the system and method of the present invention receives from a user an initial request for a quote relating to a reprint. Based on information set forth by the reprint provider of the requested reprint, the ‘quote’ is generated. The quote represents the terms under which a reprint is acquired. The quote includes a ‘cost structure’ related to the requested reprint that may be based on cost tiers associated with various reprint order quantities or other criteria. The term “cost structure” is intended to include, but is not limited to, a function, table, or other source of information, used to calculate, determine, or identify, a unit reprint cost. Based on the cost structure and the quantity of requested reprints, the unit reprint cost is determined. In certain embodiments of the present invention the cost structure may be in the form of a tiered pricing model wherein the tiers include a range of quantities of requested reprints and an associated unit reprint cost. Information related to an aggregate order, such as the unit reprint cost, may be updated upon receipt of each order or order modification. This automatic, or real-time, order aggregation and updating of information allows for users to receive up-to-date information.

According to an embodiment of the present invention, the system and method of the present invention are configured to publish a notification to one or more employees who may be potentially interested in placing a related order, and/or employees who previously placed an order associated with the quote, wherein the notification includes, at least a portion of the quote and/or quantities ordered to-date. If desired, the interested employee may place a new order or modify an outstanding order related to the quote identified in the notification. Each employee's order related to a given quote may be aggregated into a single aggregate order, thereby allowing the organization to capture a greater bulk discount.

Reprint providers may also benefit from the quote publication process. Given that interested employees will be notified of the purchasing activities of their co-worker, some employees may purchase reprints that they would not have otherwise purchased absent receipt of the publication. Therefore, the publication may act as a form of advertising for the reprint providers.

The system and method further provides for the ability to calculate in real-time the unit reprint cost, wherein the reprint unit cost is a function of the ‘aggregate quantity of requested reprints’. As used herein the term “aggregate quantity of requested reprints” is intended to include, but is not limited to, the total number of reprints ordered with respect to a given quote. Real-time calculation of the unit reprint cost allows for the unit reprint cost to be updated after the receipt of each order or order modification.

Embodiments of the present invention provide for a system and method configured to receive a request for a quote relating to the acquisition of an initial quantity of a requested reprint, wherein the quote request comprises reprint identification information; acquire a cost structure associated with the requested reprint, wherein the cost structure provides a unit reprint cost based on the quantity of reprints requested; generate the quote related to the requested reprints, wherein the quote includes the cost structure and a closing date; publish to one or more users a notification comprising some information about at least a portion of the quote; receive one or more orders in response to the notification for a period of time up to and including the closing date; determine an aggregate quantity of the requested reprint based on the orders associated with the quote, thereby producing the aggregated order; identify an applicable unit reprint cost based on the aggregate order of the requested reprint; and, after the closing date, process the aggregate order in accordance with the updated unit reprint cost.

### BRIEF DESCRIPTION OF THE DRAWINGS

The present invention will be more readily understood from the detailed description of exemplary embodiments presented below considered in conjunction with the attached drawings, of which:

FIG. 1 depicts an exemplary communications environment including an order fulfillment system, in accordance with an embodiment of the present invention;

FIG. 2 illustrates an exemplary method for aggregating reprint procurement requests, in accordance with an embodiment of the present invention;

FIG. 3 illustrates an exemplary method for managing a quote relating to the procurement of one or more reprints, in accordance with an embodiment of the present invention; and

FIG. 4 illustrates an exemplary process for publishing a notification relating to the procurement of one or more reprints, in accordance with an embodiment of the present invention.

### DETAILED DESCRIPTION OF THE INVENTION

The present invention relates to a method and a system for processing orders for the procurement of one or more reprints. As used herein, the term ‘reprint’ is intended to include, but is not limited to, any article, publication, journal, book, proceeding, patent, patent publication, newsletter, and paper, in hard-copy and/or electronic format. The order fulfillment system and method of the present invention dynamically facilitate the ordering of reprints in a centralized and controlled manner, to allow an organization including a plurality of ‘users’ to optimally realize the benefits of a bulk discount pricing structure offered by publishers of the reprints. As used herein, the term ‘organization’ is intended to include, but is not limited to, any company, corporation, entity, or the like, and the related computing environment configured to include, connect to, and/or have access to the systems and methods of the present invention. The ‘users’ may include any employee, agent contractor, individual, or computer associated with the organization that is granted permission by the organization to use, access, and/or interact with the systems and methods of the present invention.

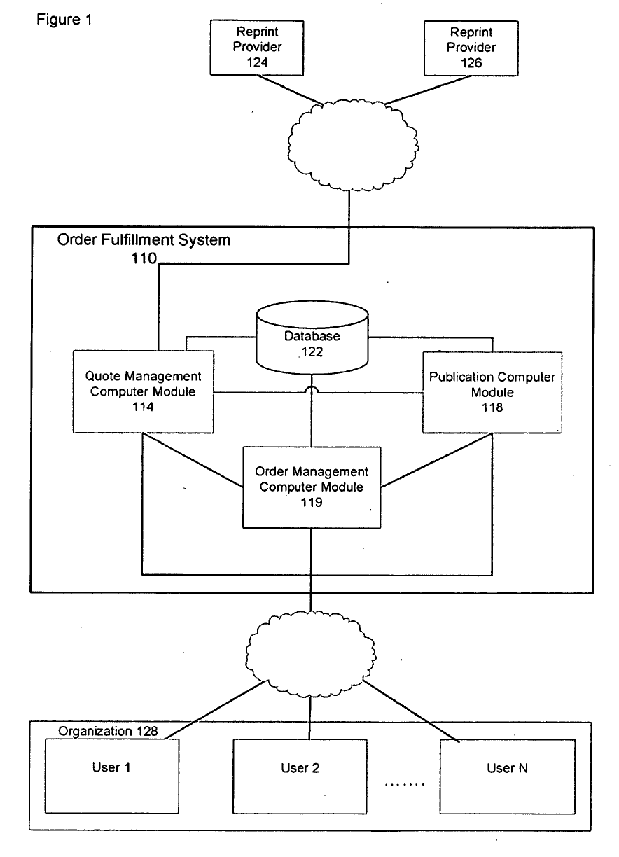

FIG. 1 depicts an Order Fulfillment System 110 according to embodiments of the present invention. The Order Fulfillment System 110 is a computer-based system, accessible by one or more users associated with the organization. The term ‘computer’ is intended to include any data processing device, such as a desktop computer, a laptop computer, a mainframe computer, a personal digital assistant, a server, a handheld device, or any other device configured to process data.

As shown in FIG. 1, the Order Fulfillment System 110 includes, but is not limited to, the following components: a Quote Management Computer Module 114, a Publication Computer Module 118, an Order Management Computer Module 119, and a Database 122. As used herein, the term ‘computer module’ is intended to include, but is not limited to, one or more computers configured to execute one or more software programs configured to perform one or more functions. The aforementioned components of the Order Fulfillment System 110 represent computer-implemented hardware and software modules configured to perform the functions described in detail below. One having ordinary skill in the art will appreciate that the components of the Order Fulfillment System 110 may be implemented on one or more communicatively connected computers. The term ‘communicatively connected’ is intended to include, but is not limited to, any type of connection, whether wired or wireless, in which data may be communicated, including, for example, a connection between devices and/or programs within a single computer or between devices and/or programs on separate computers. Each of the elements within Order Fulfillment System 110 may be communicatively connected to each other.

As illustrated in FIG. 1, the Order Fulfillment System 110 is communicatively connected to an organization 128 including a plurality of users (identified in FIG. 1 as User 1, through User N) via a network (e.g., an intranet connection, the Internet, etc.) For example, the organization 128 may be a research-oriented company having users (i.e. physicians or pharmacists) who treat patients with the company's cancer drug. In order to market the cancer drug or to support the physician treating a patient using the company's cancer drug, the users may need to acquire reprints of cancer research related articles.

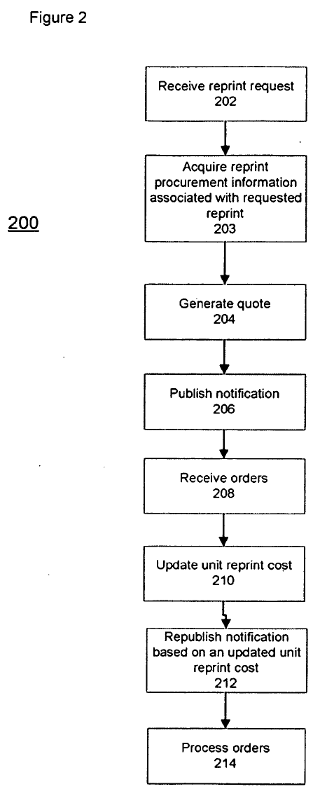

The features and functionality of embodiments of the Order Fulfillment System 110 and its components are described in detail in connection with the system diagram of FIG. 1 and the process flow diagram of FIG. 2. As shown in FIG. 1, the Order Fulfillment System 110 is communicatively connected to a plurality of Reprint Providers 124-126 via a suitable network. As used herein the term “reprint provider” is intended to include, but is not limited to, an individual or entity capable of providing a given reprint. The reprint providers supply reprints (either directly to the users or via the Order Fulfillment System 110) in accordance with requests/orders submitted by the users to the Order Fulfillment System 110. For example, reprint provider 124 may be a corporation that distributes research journals. Reprint provider 124 may distribute copies of a full journal or may distribute individual articles from a single journal. By further example, reprint provider 126 may be a university that distributes copies of articles composed by its faculty. Although FIG. 1 illustrates two reprint providers 124-126 communicatively connected to Order Fulfillment System 110, one having ordinary skill in the art will appreciate that any number of reprint providers may be connected to Order Fulfillment System 110.

The Quote Management Computer Module 114 is a computer module configured to receive a ‘quote request’ from the users of the organization 128, in step 202 of FIG. 2. A “quote request” includes an expression by a user capable of causing the generation or identification of a quote for the acquisition of a requested reprint. The quote request may include, but is not limited to, one or more of a, ‘reprint identification information,’ desired closing date, and a quantity of reprints desired. As used herein the term “reprint identification information” is intended to include any information suitable to identify a particular reprint, such as, for example, one or more of the following: title, author, citation information, volume, page numbers, edition, author, periodical information, journal name, book name, etc.

As used herein, the term “quote” is intended to include, but is not limited to, an offer for the sale of a requested reprint. The terms of such an offer are negotiated between the Order Fulfillment System 110 and the reprint provider. Information included in a quote may include, but is not limited to, the cost structure, reprint identification information, a ‘unit reprint cost,’ and a ‘closing date.’ As used herein the term “unit reprint cost” in intended to include, but it not limited to, the price of a single reprint as calculated based on the cost structure and aggregate quantity of requested reprints. The quote may also include information regarding additional costs, for example, shipping and handling, copyright license fees, and processing fees.

As used herein the term “closing date” is intended to include, but is not limited to, a date that the quote will ‘close’, after which no additional orders relating to the quote may be submitted and processed. Therefore, the closing date defines a period of time from the opening of the quote up to and including the closing date during which users may submit orders relating to the reprint(s) associated with the quote. The closing date represents the last day by which orders can be placed for reprints based on the associated quote, (i.e., the expiration date of the quote). For example, a quote may be generated having a closing date that is 30 days from the generation of the quote. As a result, after the 30 days has passed, users can no longer place orders associated with the quote.

According to an embodiment of the present invention, the closing date may be determined by the user that submits the initial reprint request, the Quote Management Computer Module 114, the organization 128, or in accordance with an established protocol. According to an embodiment of the present invention, the reprint request may include a desired date of delivery and the desired closing date. At this stage, the quote is ‘open’ such that orders may be reviewed, amended, and added by users during a period of time up to and including the closing date.

Users may place orders for the reprint indentified in the quote. As a user places an order related to a given quote, the aggregate quantity of requested reprints may be altered. A change to the aggregate quantity of requested reprints may affect the unit reprint cost. Given that the unit reprint cost is calculated or determined through the use of the cost structure and the aggregate quantity of requested reprints, a change to the aggregate quantity of requested reprints may result in a need to update the unit reprint cost. Upon the receipt of each order or order modification the aggregate quantity of requested reprints is updated which may result in an alteration of the unit reprint cost.

According to an embodiment of the present invention, a fixed cost structure is established in the quote to provide a static range to users within which the final unit reprint cost will fall. However, the value of the final unit reprint cost within the static range is not be derived until the quote is closed and the aggregate quantity of requested reprints is determined.

The Quote Management Computer Module 114 is configured to receive a plurality of quote requests from the users within an organization 128. Quote requests may be transmitted over any suitable communications network (represented by the network cloud in FIG. 1), such as the Internet or via an intranet connection.

Upon receipt of the quote request, the Quote Management Computer Module 114 may communicate with the Reprint Provider 124 in order to acquire ‘reprint procurement information,’ in step 203 of FIG. 2. The term “reprint procurement information” is intended to include, but is not limited to, information related to a given reprint that is used to generate a quote associated with the given reprint. Reprint procurement information may include, but is not limited to, a cost structure, shipping and handling cost, delivery methods, and copyright usage terms. In certain embodiments of the present invention, the Quote Management Computer Module 114 may acquire reprint procurement information manually from the Reprint Provider 124. In such an embodiment, an actor associated with the Quote Management Computer Module 114 may determine which reprint providers provide the requested reprint and contact the one or more reprint provider in order to obtain the appropriate reprint procurement information utilized during the generation of a quote. The actor may utilize a computer associated with the Quote Management Computer Module 114 to contact the reprint provider and acquire reprint procurement information. In such an embodiment, after the acquisition of reprint procurement information, the retrieved quote may be stored in a database to allow for later reuse.

In an alternative embodiment of the present invention, the Quote Management Computer Module 114 receives a quote request and automatically acquires reprint procurement information. In such an embodiment, the Quote Management Computer Module 114 automatically extracts the reprint identification information from the reprint request. Based on at least the reprint identification information, the Quote Management Computer Module 114 may automatically connect to the Reprint Provider 124 in order to acquire reprint procurement information. In such an embodiment, after the acquisition of reprint procurement information, the retrieved reprint procurement information may be stored in Database 122 to allow for reuse in the event that one or more users later request similar reprint procurement information.

In a further alternative embodiment of the present invention, the Quote Management Computer Module 114 queries the Database 122 to acquire reprint procurement information in response to a quote request. In the event that similar reprint procurement information has already been acquired and stored in the Database 122, the Quote Management Module 114 may acquire reprint procurement information from the Database 122 as opposed to contacting a reprint provider.

Based on the acquired reprint procurement information, the Quote Management Computer Module 114 generates a quote relating to the reprint request, in step 204 of FIG. 2.

As shown in FIG. 1, the Publication Computer Module 118 is a computer module configured to publish one or more ‘notifications’ based on the generated quotes, in step 206 of FIG. 2. As used herein, the term “notification” is intended to include, but is not limited to, a communication (e.g., an advertisement, alert, posting, etc.) used to inform one or more users within the organization 128 of a pending (i.e., open) quote or updated unit reprint cost. By publishing the notification to users potentially interested in ordering the requested reprint, the Order Fulfillment System 110 promotes focused, centralized, procurement by users to optimize the organization's ability to leverage bulk discounts offered by the reprint providers.

The period within which the one or more notification may be published and the one or more orders may be received is herein referred to as the ‘advertising period.’ The advertising period for a quote begins when the quote is opened for orders and ends when the quote closes (i.e., at the closing date).

In step 206, the Publication Computer Module 118 reviews the pending quote, determines which users will receive the notification, establishes how the notification will be published, prepares the ‘notification information’ to be included in the notification, and determines the frequency of the notification. The “notification information” may include, but is not limited to, one or more of the quote or a portion thereof, at least a portion of the reprint identification information, the cost structure, the current unit reprint cost, the current aggregated quantity of requested reprints, information identifying the one or more users that submitted an order related to the quote, a list of the users receiving the notification, savings calculation, and/or the closing date.

In reference to the savings calculation, the system and method of the present application may provide for at least three types of savings. One type of saving is the ‘bulk saving.’ The term “bulk savings” is intended to include, but is not limited to, the amount of money saved, (i.e., the discount realized) when a single user purchases multiple copies of a reprint as opposed to purchasing a single reprint. A second type of savings is the ‘aggregate savings.’ The term “aggregate savings” is intended to include, but is not limited to, the amount of money saved when orders by a plurality of users are aggregated into a single order as opposed to each user purchasing a particular order quantity independently of other users.

The Publication Computer Module 118 may transmit the notification via any suitable medium and in any suitable format, including, but not limited to, e-mail, letter, text message, website posting, or voice mail. Database 122 may be configured to store information that can be used by the Publication Computer Module 118 in generating the notification, including information that enables the Publication Computer Module 118 to determine the users that are to receive the notification.

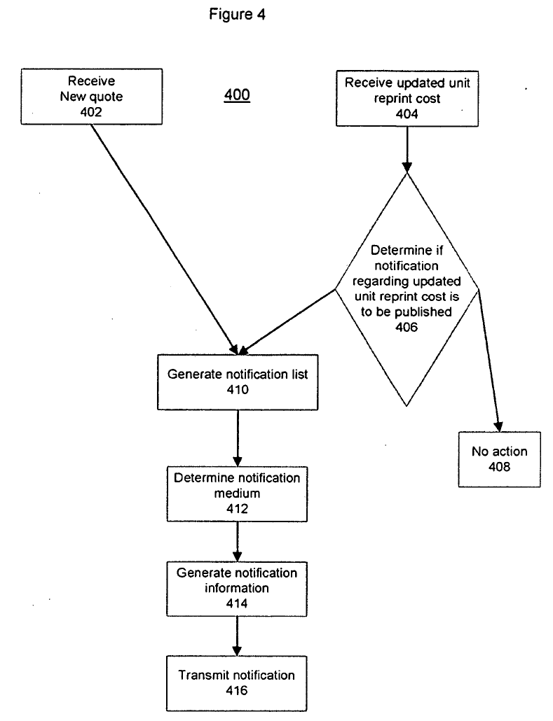

The Publication Computer Module 118 determines which users will receive the notification based on notification factors including, but not limited to, one or more users' purchasing activity or history, the identity of other users requesting the reprint associated with the quote, the content and/or nature of the requested reprint, membership in a user notification group, or other similar factors. For example, the quote may be associated with the acquisition of an article regarding cancer research. As a result, purchasing history information may be queried to determine which users have purchased cancer related articles in the past, these users may receive a notification regarding the quote. The query may be customized in order to optimize the effectiveness of the notification. In a second example, a user may subscribe to a user ‘notification list.’ As used herein the term “notification list” is intended to include, but is not limited to, a list of users that may to receive a notification relating to a given quote. For example, the notification list may be configured to alert a specified set of users to a reprint quote associated with a specified subject area. FIG. 4 illustrates an exemplary process 400 for performing the notification publication process (step 206 of FIG. 2), according to an embodiment of the present invention. As shown in FIG. 4, the notification publication process begins with step 402, wherein the Publication Computer Module 118 receives a new quote from the Quote Management Computer Module 114. It is to be appreciated that the Publication Computer Module 118 may also publish additional notifications during the advertisement period. Additional notifications during the advertising period may be triggered by a modification to an element related to a quote, such as, but not limited to, the unit reprint cost or aggregate quantity of request reprints.

As shown in FIG. 4, in step 404, the Publication Computer Module 118 receives an updated unit reprint cost. Next, in step 406, the Publication Computer Module 118 determines whether a notification should be made regarding the updated unit reprint cost. In this regard, the Publication Computer Module 118 may be configured to consider any suitable factors to determine whether a notification is needed, wherein these notification factors may be customized and configured by the organization 128. For example, the notification factors may establish thresholds that determine when a quote should trigger a notification, such as, requiring that a notification be published every time the unit reprint cost changes. According to another example, the notification factors may dictate that a notification only be transmitted in the instance where the unit reprint cost has been altered by a certain amount (i.e., a 10% reduction). Moreover, the notification factors may provide for the transmission of a notification based on features or the quote other than unit reprint cost, such as aggregated quantity of requested reprints. Based on a review of the notification factors, the Publication Computer Module 118 may determine that a notification is not needed, in step 408. If the Publication Computer Module 118 determines that a notification is needed, process 400 continues to step 410.

It may be important to publish one or more additional notifications in order to inform users of pending orders related to a given quote because such a change may alter the projected cost of the individual user's order. In addition to informing a user that has a related order, an additional notification may also be directed to users who may be interested in the requested reprint, but have yet to place an order. It is advantageous to notify users of a decrease in the applicable unit reprint cost associated with the quote, because such a change may make the acquisition of the associated reprint more appealing. Given that the unit reprint cost may be updated after the receipt of every order or order modification, embodiments of the present invention may publish notifications after the receipt of each order or order modification.

At step 410, the Publication Computer Module 118 generates a notification list. The notification list provides the identity of users that will receive the notification. According to an embodiment of the present invention, a user may select which notification they receive. For example, a user may establish that he or she wishes to receive every notification related to reprint of a document pertaining to a certain subject matter. According to another example, a user may subscribe to a user group, therefore, whenever a notification is generated related to a quote for which another user group member has order a reprint, the user will receive the notification. One having ordinary skill in the art will appreciate that other methods of subscribing to the receipt of notifications may be implemented in accordance with the present invention.

In addition to generating a notification list of users that have affirmatively requested the receipt of a given type of notification, the Publication Computer Module 118 may also dynamically add users to the notification list. Through querying purchasing history information stored in a database, the Publication Computer Module 118 may determine that certain users may be interested in the quote. This may be accomplished through matching similar subjects matters, authors, purchasers, or and other data elements associated with the quote. A combination of multiple elements may also be used to determine which users should be included on the notification list. According to embodiments of the present invention, only users eligible to place an order with respect to a particular quote will be included on the notification list for the given quote.

According to an embodiment of the present invention, the requested reprint for which the quote is generated may also dictate which users are to receive a notification. Within an organization 128 there may be different classes of users having different procurement permission levels. As a result, not all users may have the authority to place orders in response to a given quote. For example, a quote between an organization 128 and a reprint provider 124, 126 may provide for reprints and/or related fulfillment services that have a premium pricing component. These premium pricing services may include rush orders, customized printing, or limited release reprints. Some organizations 128 may desire to restrict purchasing of premium items to user of a given class. As a result, not all users may be granted permission to initiate the generation of a quote or place an order in response to a quote that related to a reprint that falls within one of the premium reprint categories. Given that certain users may be restricted from placing an order in response to a quote, restricted users may be filtered from receiving a notification related to the restricted reprints. For example, a user may subscribe to receive all notification related to quotes addressing the topic of ‘wireless communication networks’. In the event that a quote is generated regarding premium reprints related to wireless communication technology, the users may only receive the related notifications in the event that the user is a member of the class of people authorized to place an order for such premium reprints. This allows notifications to be targeted at users that are capable of placing an order related to the notification.

With reference FIG. 4, following the generation of the notification list (at step 410), the Publication Computer Module 118 determines the medium for the notification, at step 412. In so doing, the Publication Computer Module 118 may review the quote to determine if the user requested a preferred medium or mediums for the notification publication. Users may also select different mediums based on certain aspects of the quote, such as proximity to the quote closing date. According to an embodiment of the present invention, default preferences may be established at the time that a user account is created. Furthermore, the organization 128 may also establish a default medium for all notifications published to its users.

The Publication Computer Module 118 also generates or identifies and formats the notification information to be contained in the notification, in step 414. One having ordinary skill in the art will appreciate that the notification information may be generated prior to or following the determination of the notification medium. Users may dictate the type of notification information to be included in notifications they receive, as well as a preferred format of the notification. A default setting for the notification information and related formatting may also be established by the organization 128. Finally, in step 416, the finalized notification is published (i.e., transmitted) in accordance with steps 410, 412, and 414.

Process 400 may be executed each time the aggregate quantity of requested reprints is updated. As a result, adjustment of the unit reprint cost based on the aggregate quantity of requested reprints may be communicated to one or more users, allowing for notification of real lime pricing information.

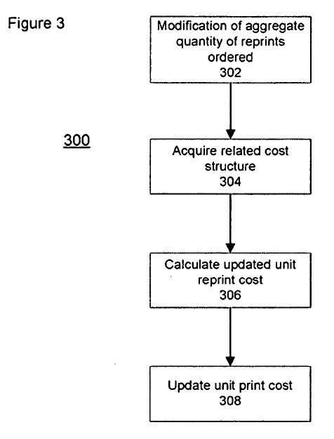

With reference to FIGS. 1 and 2, the Order Fulfillment Module 110 further comprises the Order Management Computer Module 119. The Order Management Computer Module 119 is configured to receive one or more orders associated with a given quote while during the advertising period, at step 208 of FIG. 2. During the advertising period, users may place, modify, or cancel orders for the requested reprint. Upon receipt of one or more additional orders, the Order Management Computer Module 119 may update the applicable unit reprint cost, at step 210 of FIG. 2. Each order associated with the quote is aggregated, thereby creating a single aggregate quantity of requested reprints related to the ‘aggregate order’. The term “aggregate order” is intended to include, but is not limited to, an order that represents an aggregation of all individual orders placed against or in association with a given quote. As a result, an order placed for a reprint associated with the quote results in a change to the aggregate quantity of requested reprints associated with the quote. Given that the unit reprint cost is dictated by a cost structure and an aggregate quantity of requested reprints, a change to the aggregate quantity of requested reprints may cause the unit reprint cost to change. Therefore, the unit reprint cost may be updated, thereby producing an updated unit reprint cost, in step 210. The process of updating a unit reprint cost is discussed in further detail below in reference to FIG. 3, according to an embodiment of the present invention.

FIG. 3 illustrates an exemplary process for updating the unit reprint cost, as executed by the Order Management Computer Module 119. Process 300 begins with receipt by the Order Management Computer Module 119 of information that alters the aggregate quantity of requested reprints related to a given quote, at step 302. This may come in the form of an additional order from a user or the manipulation of an existing order. Following the receipt of a change to the aggregate quantity of requested reprints, at step 302, the Order Management Computer Module 119 retrieves the cost structure related to the quote.

Having retrieved the cost structure, the Order Management Computer Module 119 calculates the unit reprint cost based on the ‘updated aggregate quantity of requested reprints.’ As used herein, the term “updated aggregate quantity of requested reprints” is intended to include, but is not limited to, the current number of reprints ordered with respect to a given quote. Based on the updated aggregate quantity of requested reprints and the cost structure, the updated unit reprint cost is calculated. Once the updated unit reprint cost has been calculated, the Quote Management Computer Module 114 updates the unit reprint cost, at step 308. As a result of aggregating the orders and requests for reprints into the aggregate order, the updated unit reprint cost may provide a discount over the previously determined unit reprint cost (i.e., the unit reprint cost applicable pursuit to the aggregate order).

In view of the updated unit reprint cost, a notification publication may be triggered. If triggered, the Publication Computer Module 118 may be configured to publish a notification based on an updated unit reprint cost, in step 212 of FIG. 2. The notification publication process is described above in detail with reference to step 206 in FIG. 2 and process 400 in FIG. 4. Finally, once the quote closes (i.e., after the closing date), the Order Management Computer Module 119 processes the orders associated with the quote, in step 214. According to an embodiment of the present invention, once the quote closes, orders may no longer be placed for the requested reprint. Users who desire the reprint associated with a closed quote may need to initiate the generation of a new quote. In certain embodiment of the present invention the closing date of a quote may be extended after the quote is generated.

The Order Management Computer Module 119 is further configured to process orders following the closing of a quote, in step 214 of FIG. 2. This may include placing an order with Reprint Provider 124, 126 and facilitating the delivery of the reprints to the organization 128 or directly to specific users. Depending on the form of requested reprints, or the form in which the Reprint Provider 124, 126 offers reprints, the reprints may be delivered in either paper or electronic form. In an instance where electronic reprints are provided, reprint providers may transmit reprints in an e-mail or allow for users to download reprints via a network.

In addition, the Order Management Computer Module 119 may generate invoices related to the orders placed. The Order Management Computer Module 119 may be configured to provide a single invoice to the organization 128 for the aggregate quantity of requested reprints. Alternatively, the Order Management Computer Module 119 may be configured to provide invoices related to individual users or user groups.

Given that the unit reprint cost for reprints may fluctuate while the quote is open based on the receipt of each additional orders or modifications to existing orders, a ‘final’ unit reprint cost may be established in step 214. The ‘final unit reprint cost’ is calculated by associating the aggregate quantity of requested reprints ordered with the cost structure. As used herein the term “final unit reprint cost” is intended to include, but is not limited to, the calculated price for the purchase of a reprint based on the aggregated quantity of requested reprints. For example, if the cost structure dictates that the unit reprint cost is $1.00 if the aggregate quantity is between 100 and 200 reprints, the final unit reprint cost will be $1.00 if 145 reprints are ordered. In instances where the quote involved a groups of users that each receive individual invoices for their orders, the reprint cost will be the same for all users that order reprints in response to the given quote. In reference to the prior example, a user that placed an order when the aggregate quantity of requested reprints was 50 will be charged the same unit reprint cost as the user who ordered his or her reprint when the aggregate quantity of requested reprints was 130 reprints. Therefore, once the final unit reprint cost is established it will be used to calculate the total cost for each individual order.

According to an embodiment of the present invention, the Order Management Computer Module 119 establishes the ‘final order,’ in step 214. As used herein the term “final order” is intended to include, but is not limited to, the total orders relating to a quote associated with a requested reprint. In addition, the Order Management Computer Module 119 in step 214 may facilitate the delivery of the ordered reprints. In certain embodiments of the present invention, the Order Management Computer Module 119 may acquire all reprints associated with the aggregate order from the Reprint Provider 124, 126 and provide them to the organization 128 or the individual users. In such an embodiment, the Order Management Computer Module 119 may place a single order to the appropriate reprint provider, and upon receiving copies of the requested reprint, the entity may partition the copies based upon each individual order. The partitioned orders are then delivered to the corresponding individual users. Alternatively, the Reprint Provider 124, 126 may deliver the reprints directly to the organization 128 or the individual users.

Employees within a given organization who are responsible for managing the procurement of reprints may have the ability to provide tiered access to different groups of users. As a result, some users may be restricted from ordering reprints that carry a premium charge, or users may be limited to placing orders that exceed a given dollar amount or quantity of reprints. In the instance when premium content is available, notifications may be published to target employees that qualify for ordering premium reprints.

In alternative embodiments of the present invention, certain authorized users are provided the option to place orders on-behalf-of another user. Ordering on-behalf-of another allows a given user to place an order for a reprints where the order becomes associated with another user. For example, a first user may find an open quote for a scientific article related to leading factors of global warming. The first user may place an order for this article where the order is processed as if it had been ordered by the second user. Ordering on-behalf-off may allow a single user to perform the task of placing orders for a group of users. For security purposes, a user, company, or organization may be required to pre-authorize users who may order on their behalf or verify orders placed on their behalf.

In addition to benefits derived by reprint purchasers, reprint providers may benefit from the present invention because the publication of a notification may result in a user's request for a reprint in a situation where the user would not have otherwise been aware of the reprint ordering opportunity. Furthermore, a reduction to the reprint cost may result in an increase of aggregate quantity of requested reprints, thereby resulting in an increase in revenue associated with a given reprint.

One skilled in the art will appreciate that the present invention can be practiced by other that the described embodiments, which are presented from purposes of illustration and not of limitation, and the present invention is limited only by the claims which follow.

1. A computer implemented method for processing an aggregate order for acquisition of a reprint, the method comprising the steps of:
receiving a request for a quote relating to the acquisition of an initial quantity of a requested reprint, wherein the quote request comprises reprint identification information;
acquiring a cost structure associated with the requested reprint, wherein the cost structure provides a unit reprint cost based on the quantity of reprints requested;
generating the quote related to the requested reprint, wherein the quote includes the cost structure and a closing date;
publishing to one or more users a notification comprising at least a portion of the quote;
receiving an order in response to the notification for a period of time up to and including the closing date;
determining an aggregate quantity of the requested reprint based on the order associated with the quote, thereby producing the aggregated order;
identifying an applicable unit reprint cost based on the aggregate order of the requested reprint; and
after the closing date, processing the aggregate order in accordance with the updated unit reprint cost.

2. The method of claim 1, further comprising publishing to the one or more users a notification, subsequent to identifying an applicable unit reprint cost based on the aggregate order.

3. The method of claim 1, wherein the step of processing the aggregate order comprises delivering the requested reprint to the one or more users associated with the aggregate order.

4. The method of claim 1, wherein the step of publishing to one or more users a notification comprising at least a portion of the quote comprises determining the identity of the one or more users.

5. The method of claim 1, wherein the step of publishing to one or more users a notification comprising at least a portion of the quote comprises querying a database to identify the one or more users.

6. The method of claim 1, further comprising receiving one or more orders unrelated to the notification for a period of time up to and including the closing date.

7. The method of claim 1, wherein the step of processing aggregate order comprises calculating an aggregate savings associated with the aggregate order.

8. An order fulfillment system comprising:
the quote management computer module communicatively connected to a publication computer module and order management computer module, the quote management computer module configured to:
receive a request for a quote relating to the acquisition of an initial quantity of a requested reprint, wherein the quote request comprises reprint identification information,
generate an quote related to the requested reprints, wherein the quote includes the cost structure, reprint identification information, and a closing date, and
acquire a cost structure associated with the requested reprints, wherein the cost structure provides unit reprint cost based on the initial quantity of reprints requested;
the publication computer module communicatively connected to the quote management computer module, the publication computer module configured to:
publish to one or more users a notification comprising at least a portion of the quote reprint; and
the order management computer module communicatively connected to the quote management computer module, the order management computer module configured to:
receive an order in response to the notification for a period of time up to and including the closing date,
determine an aggregate quantity of the requested reprint based on the order associated with the quote, thereby producing the aggregated order,
identify an applicable unit reprint cost based on the aggregate order of the requested reprint, and
process the aggregate orders in accordance with the applicable unit reprint cost.

9. The order fulfillment system of claim 8, wherein the publication computer module is communicatively connected to the order management computer module, configured to:
publish to the one or more users a notification, subsequent to the order management computer module identifying the applicable unit reprint cost based on the aggregate order.

10. The order fulfillment system of claim 8, wherein the order management computer module is configured to deliver each of the plurality of orders to each of the one or more corresponding users.

11. The order fulfillment system of claim 8, wherein the publication computer module, configured to query a communicatively connected database to identify the one or more users.

12. The order fulfillment system of claim 8, wherein the order management computer module is configured to receive one or more orders unrelated to the notification for a period of time up to and including the closing date.

13. The order fulfillment system of claim 8, wherein the order management computer module is configured to calculate an aggregate savings associated with the aggregate order.
